(19) United States
(12) Patent Application Publication
(10) Pub. No.: US 2026/0329513 A1
(43) Pub. Date: Oct. 22, 2026

(54) INFORMATION PROCESSING METHOD AND APPARATUS, DEVICE, AND MEDIUM

(71) Applicant: Beijing Zitiao Network Technology Co., Ltd., Beijing (CN)

(72) Inventors: Danni WU, Beijing (CN); Jiankuan XING, Beijing (CN); Jingwen GUO, Beijing (CN)

(21) Appl. No.: 18/993,952

(22) PCT Filed: Aug. 11, 2023
(86) PCT No.: PCT/CN2023/112524

§ 371 Date: Jan. 13, 2025

(30) Foreign Application Priority Data
Aug. 12, 2022 (CN) 202210968136.6
Aug. 12, 2022 (CN) 202210970414.1

(51) Int. Cl. G06F 3/14; G06F 3/0483; G06F 3/0484; G06F 9/451; G06F 21/62

(52) U.S. Cl. CPC G06F 3/1454; G06F 3/0483; G06F 3/0484; G06F 9/451; G06F 21/6218

(57) ABSTRACT

A method of information processing and a method of task processing are provided. The method of information processing includes, obtaining a task identifier corresponding to a first task in response to a first preset operation about the first task triggered by a first user; and displaying the task identifier in an interface of a target object in response to a second preset operation triggered by the first user, so that a second user having an access permission to the target object views information corresponding to the first task through the task identifier.

The present application claims priority to Chinese Patent Application No. 202210968136.6, filed on Aug. 12, 2022 and entitled “INFORMATION DISPLAY METHOD AND APPARATUS, DEVICE, AND MEDIUM”, and Chinese Patent Application No. 202210970414.1, filed on Aug. 12, 2022 and entitled “TASK PROCESSING METHOD AND APPARATUS, ELECTRONIC DEVICE, AND MEDIUM”, which are incorporated herein by reference in their entireties.

### TECHNICAL FIELD

The present application relates to the field of computer technologies, and in particular, to a method and an apparatus of information processing, a device, and a medium.

### BACKGROUND

To improve efficiency of collaboration, more and more applications that are convenient for meeting user requirements have emerged. Among them, a task application has become an important assistant for work, which can create a task for himself/herself or create a common task for a plurality of other users. By creating a task, it can remind himself/herself and other collaborators of the task to participate in or perform a specific task. In addition, the task can also be shared among related parties to achieve the following: notifying related parties of the task to participate in or pay attention to an execution progress of the task. However, the current task sharing function is relatively simple and cannot meet more requirements of users, affecting user experience.

### SUMMARY

In view of the above, the embodiments of the present application provide a method and an apparatus of information processing, a device, and a medium, to display detailed information about a task by triggering a task identifier, so that a user can view the detailed information conveniently, and user experience is improved.

To achieve the above purpose, the technical solution provided by the present application is as follows:

In a first aspect of the present application, a method of information processing is provided. The method includes:
obtaining a task identifier corresponding to a first task in response to a first preset operation about the first task triggered by a first user; and
displaying the task identifier in an interface of a target object in response to a second preset operation triggered by the first user, so that a second user having an access permission to the target object views information corresponding to the first task through the task identifier.

In a second aspect of the present application, a method of task processing is provided. The method includes:
receiving a task analysis request triggered by a user, where the task analysis request indicates a first task identifier;
when an analysis result corresponding to the first task identifier includes at least two candidate tasks, displaying related information of the at least two candidate tasks, where the related information includes tenant information corresponding to each candidate task; and
in response to an operation of the user selecting one of the candidate tasks as a target task, displaying the first task identifier in a first preset style, where the first task identifier displayed in the first preset style is capable of being triggered to display content of the target task.

In a third aspect of the present application, an apparatus of information processing is provided. The apparatus includes:
an obtaining unit, configured to obtain a task identifier corresponding to a first task in response to a first preset operation about the first task triggered by a first user; and
a display unit, configured to display the task identifier in an interface of a target object in response to a second preset operation triggered by the first user, so that a second user having an access permission to the target object views information corresponding to the first task through the task identifier.

In a fourth aspect of the present application, a method of task processing is provided. The apparatus includes a receiving module and a processing module,
the receiving module is configured to receive a task analysis request triggered by a user, where the task analysis request indicates a first task identifier;
the display module is configured to, when an analysis result corresponding to the first task identifier includes at least two candidate tasks, display related information of the at least two candidate tasks, where the related information includes tenant information corresponding to each candidate task; and
the processing module is configured to, in response to an operation of the user selecting one of the candidate tasks as a target task, display the first task identifier in a first preset style, where the first task identifier displayed in the first preset style is capable of being triggered to display content of the target task.

In a fifth aspect of the present application, an electronic device is provided. The device includes a processor and a memory.

The memory is configured to store instructions or a computer program.

The processor is configured to execute the instructions or the computer program in the memory, so that the electronic device executes the method according to the first aspect or the second aspect.

In a sixth aspect of the present application, a computer-readable storage medium is provided. Instructions are stored in the computer-readable storage medium. When the instructions are run on a device, the device is caused to execute the method according to the first aspect or the second aspect.

In a seventh aspect of the present application, a computer program product is provided. The computer program product includes a computer program/instruction, and when the computer program/instruction is executed by a processor, the method according to the first aspect or the second aspect is implemented.

As shown, the embodiments of the present application have the following beneficial effects:

In the embodiments of the present application, when a first user triggers a first preset operation for a first task, a task identifier corresponding to the first task is obtained based on the first preset operation. After the task identifier corresponding to the first task is obtained, when the first user triggers a second preset operation, the task identifier is displayed in an interface of a target object based on the second preset operation, so that a second user having an access permission to the target object views information corresponding to the first task through the task identifier. That is, the information corresponding to the first task is displayed by triggering the task identifier, which is convenient for the user to view the information, to improve user experience.

By receiving a task analysis request triggered by a user, when an analysis result corresponding to the first task identifier includes at least two candidate tasks, related information of the at least two candidate tasks is displayed, where the related information includes tenant information corresponding to each candidate task. Therefore, the user can determine one of the candidate tasks as a target task based on the related information of the candidate tasks. In response to an operation of the user selecting one of the candidate tasks as the target task, the first task identifier is displayed in a first preset style. The first task identifier displayed in the first preset style can be triggered to display content of the target task. Therefore, a task identifier of a user across tenants can be analyzed.

### BRIEF DESCRIPTION OF DRAWINGS

In order to more clearly describe the technical solutions in the embodiments of the present application or in the prior art, the following briefly introduces the accompanying drawings required for describing the embodiments or the prior art. Apparently, the accompanying drawings in the following description show merely some embodiments of the present application, and a person of ordinary skill in the art may still derive other drawings from these accompanying drawings without creative efforts.

FIG. 1 is a flowchart of a method of information processing according to an embodiment of the present application;

FIG. 2a is a schematic diagram of a task identifier displayed on a selection page according to an embodiment of the present application;

FIG. 2b is a schematic diagram of a task identifier displayed on another selection page according to an embodiment of the present application;

FIG. 2c is a schematic diagram of a task details page according to an embodiment of the present application;

FIG. 3a is a schematic diagram of a task details page displayed in a chat interface according to an embodiment of the present application;

FIG. 3b is a schematic diagram of a task card display according to an embodiment of the present application;

FIG. 4 is a schematic flowchart of a method of task processing according to an embodiment of the present application;

FIG. 5 is a schematic diagram of a chat interface according to an embodiment of the present application;

FIG. 6A to FIG. 6C are other schematic diagrams of a chat interface according to an embodiment of the present application;

FIG. 7A1 to FIG. 7C2 are schematic diagrams of identifier information of a task in an analyzable state according to an embodiment of the present application;

FIG. 8 is a schematic flowchart of another method of task processing according to an embodiment of the present application;

FIG. 9A to FIG. 9C are a schematic diagram of an interface for analyzing identifier information according to an embodiment of the present application;

FIG. 10 is a schematic flowchart of another method of task processing according to an embodiment of the present application;

FIG. 11A to FIG. 11C are another schematic diagram of an interface for analyzing identifier information according to an embodiment of the present application;

FIG. 12 is a schematic diagram of an apparatus of information processing according to an embodiment of the present application;

FIG. 13 is a schematic diagram of a structure of an apparatus of task processing according to an embodiment of the present application; and

FIG. 14 is a schematic diagram of a structure of an electronic device according to an embodiment of the present application.

### DETAILED DESCRIPTION

To make persons skilled in the art better understand the solutions of the present application, the following clearly and completely describes the technical solutions in the embodiments of the present application with reference to the accompanying drawings in the embodiments of the present application. Apparently, the embodiments described are some rather than all of the embodiments of the present application. All other embodiments obtained by a person of ordinary skill in the art based on the embodiments of the present application without creative efforts shall fall within the protection scope of the present application.

In an enterprise, to facilitate communication between employees, an enterprise collaboration software is configured, so that employees can perform real-time communication and collaboration between two or more persons by installing a client of the collaboration software. The collaboration software is a suite software that integrates any of a plurality of functions such as an address book, an instant messaging tool, a meeting, a cloud document, a workbench, a task center, a calendar, an email.

A task application in the collaboration software is a lightweight task management tool with powerful collaboration capability, and a user can view all tasks related to the user in the task center. The user can easily and quickly create a task in a chat or the like, or share an interested task with a related member, or follow some interested tasks. In addition, the user can discuss the task or the like. When creating a task, the user can add a reminder time, a follower, and a collaborator to the task. How to quickly share a task with another user is a technical problem to be urgently solved.

Based on this, an embodiment of the present application provides a method of information processing. For each created task, a task identifier is allocated to the task. A task identifier corresponding to a first task is obtained in response to a first preset operation for the first task triggered by a first user. The task identifier is displayed in an interface of a target object in response to a second preset operation triggered by the first user, so that a second user having an access permission to the target object views information corresponding to the first task through the task identifier. That is, in the present application, the task identifier is displayed in the interface of the target object, so that the user can view detailed information corresponding to the first task based on the task identifier, providing an entry for the user to quickly view the task information and improving user experience.

The target object may be another application in the collaboration software, for example, a cloud document, a chat, an email box, an audio/video meeting, or may be a comment area of a task, a comment area of a document, or the like.

To make it easier to understand the technical solutions provided in the embodiments of the present application, the following describes the solutions with reference to the accompanying drawings.

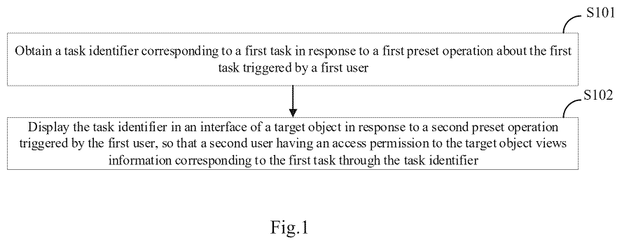

FIG. 1 is a flowchart of a method of information processing according to an embodiment of the present application. The method may be performed by an information display client, and the information display client may be installed in an electronic device. The electronic device may include a device with a communication function, such as a mobile phone, a tablet computer, a notebook computer, a desktop computer, a vehicle-mounted terminal, a wearable electronic device, an all-in-one machine, or a smart home device, or may be a device simulated by a virtual machine or a simulator. As shown in FIG. 1, the method may include the following steps.

Step S101: Obtain a task identifier corresponding to a first task in response to a first preset operation about the first task triggered by a first user.

In this embodiment, when the first user wants to share a specific task in the target object or wants to transfer a created task among different applications in the suite software, the task identifier corresponding to the first task is obtained based on the first preset operation for the first task triggered by the first user. The task identifier is an identifier allocated by a task server to the created task when the task is created, to distinguish the task from other tasks. The user can create a task in a plurality of business scenarios such as a task center, a chat, or a cloud document.

The task identifier may be represented as a specific character+a preset number of digits, for example, t+six digits. An expression form of the task identifier may be set according to an actual application, which is not limited in this embodiment. To make it easier to understand the solution, the following uses the task identifier as t+six digits as an example for illustration.

Obtaining the task identifier corresponding to the first task in response to the first preset operation about the first task triggered by the first user may be implemented in one or more of the following manners:

In one manner, in response to a preset symbol input by the first user in an input area in an interface of the target object, the preset symbol is obtained, a task identifier including the preset symbol is displayed, and in response to a selection operation triggered by the first user in the displayed task identifier, the selected task identifier is obtained. That is, when the first user inputs the preset symbol in the input area in the interface of the target object, one or more task identifiers including the preset symbol and task description information are displayed. The first user can select a required task identifier from the displayed task identifiers based on the task description information. The preset symbol is related to the expression form of the task identifier and the preset symbol is used to display the task identifier including the preset symbol. For example, if the task identifier is t+six digits, the preset symbol may be t+four digits. When the target object detects the user inputting t+four digits, a plurality of task identifiers including the preset symbol are displayed for the first user to select. The task description information may include a task title and a tenant identifier to which the task belongs.

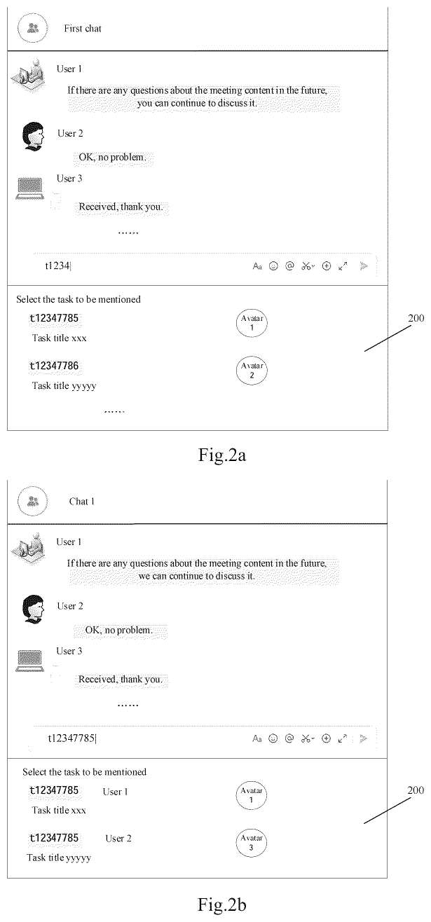

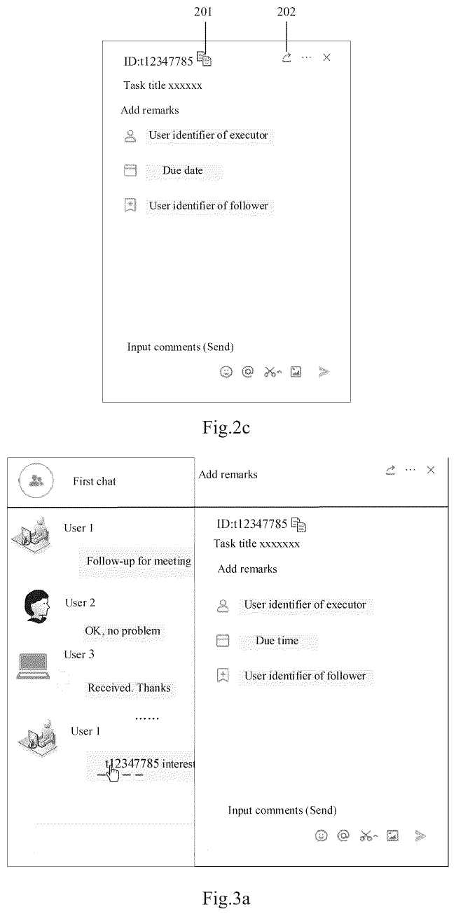

For example, as shown in FIG. 2a, the first user inputs “t1234” in chat 1, and a selection page 200 is displayed. The task corresponding to a task identifier “t12347785” including “t1234” and the task corresponding to a task identifier “t12347786” may be displayed on the selection page 200. As shown in FIG. 2a, the selection page 200 may display not only the task identifier, but also task description information such as a task title corresponding to the task identifier and a user avatar of a user who creates the task. The first user can make a selection on the selection page 200. In response to a selection operation of the first user, the selected task identifier is obtained. The selection page 200 may be displayed below an input box as shown in FIG. 2a. In another embodiment, the selection page 200 may be displayed above the input box, which is not limited here.

In a same tenant, task identifiers of different tasks are also different, that is, the task identifiers are unique within the tenant. However, there may be tasks with the same task identifier but different task content between different tenants. The first user belongs to tenant 1, and has a collaboration relationship with a user in tenant 2 and adds the user as a contact. Therefore, the user in tenant 2 can create a task in tenant 2 and set the first user as an executor or a follower. In this case, the first user has tasks associated with the first user in different tenants, and task identifiers of the associated tasks of the first user in different tenants may be the same. For example, as shown in FIG. 2b, the user inputs “t12347785”, and different tasks with the same task identifier are displayed on the selection page 200. A first task belongs to tenant 1, and a second task belongs to tenant 2.

In another manner, a task identifier corresponding to the first task is obtained in response to a copy or share operation of the first task triggered by the first user. That is, when the first user triggers a copy operation or a share operation for a specific task, the task identifier corresponding to the task is obtained. The first user may trigger the copy or share operation in any object including the first task, for example, trigger the copy or share operation in a task center or a cloud document including the first task. Specifically, when the first user enters the task center, various tasks created or participated in by the first user may be displayed on a page of the task center. When the first user wants to share a specific task, the first user enters a task details page corresponding to the task, and the task details page displays a task identifier and a share control corresponding to the task. In response to the first user copying the task identifier or triggering the share control, the task identifier corresponding to the task can be obtained.

For example, as shown in a task details page in FIG. 2c, the task details page displays a task identifier “t12347785”, a copy control 201, and a share control 202. The first user obtains the task identifier through the copy control 201, or the first user obtains a share link including the task identifier through the share control 202.

Step S102: Display the task identifier in an interface of a target object in response to a second preset operation triggered by the first user, so that a second user having an access permission to the target object views information corresponding to the first task through the task identifier.

In the method shown in FIG. 1, the information corresponding to the first task is displayed by triggering the task identifier, so that the user can view the information conveniently, and user experience is improved. In addition, the task can be conveniently shared and transferred in the office suite by using the task identifier, improving work efficiency.

In the embodiments of the present disclosure, an AppLink-based manner may be used. Each task has a unique applink for identification. For example, an applink identifier corresponding to task t102382 is https://applink.xxx.yyy . . . =t102382. Each applink uniquely identifies a task. When a copy operation is performed on the task, the back end generates the unique applink. When the applink is input in a message input box/document, the applink is automatically identified, and a url rich text data structure is generated. Display content is t102382, and the display content may be hovered and clicked. Before hovering, the client initiates a request to obtain specific information about the task, such as a title and a permission. Therefore, when hovering, the client can determine whether the user has a permission to access the task. According to the permission, “gray” (un-accessible) and “blue” (accessible) are distinguished. After the user clicks, the client is triggered to display task details.

After the task identifier corresponding to the first task is obtained, the task identifier is displayed in an interface of the target object based on the second preset operation triggered by the first user. When a user (second user) having an access permission to the target object accesses the target object, information corresponding to the first task can be viewed through the task identifier displayed in the target object. The second user may be the first user or another user, which is not limited in this embodiment.

In some implementations, the method further includes: displaying a task details page corresponding to the task identifier in response to a trigger operation on the task identifier by a second user, where the task details page is used to display detailed information of the first task. The detailed information includes information such as a task identifier, an executor, a collaborator, a due time, and a comment.

Displaying the task details page by using the task identifier includes the following implementations:

In one implementation, the task details page is displayed in an interface in which the task identifier is displayed in response to the trigger operation on the task identifier by the second user. That is, the task details page is displayed in the interface of the target object. The task details page may be displayed on the interface of the target object in a sidebar manner or be displayed on the interface of the target object in a bottom pop-up window manner.

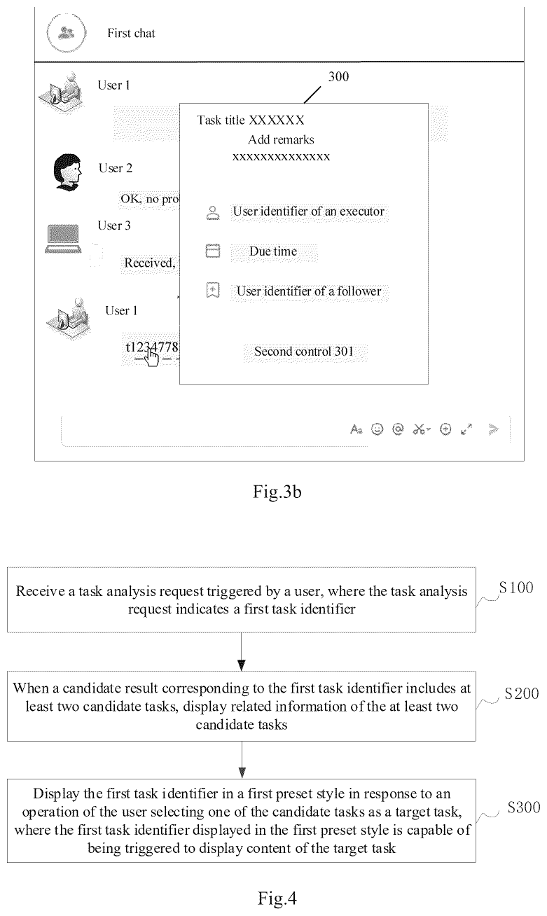

For example, FIG. 3a is a schematic diagram of a task details page display. The target object is a first chat, and in response to a trigger operation on a task identifier by a user, a task details page is displayed on the interface of the first chat in a sidebar manner.

In one implementation, it is jumped to a task center and the task details page is displayed in the task center in response to the trigger operation on the task identifier by the second user. That is, when the second user triggers the task identifier in the target object, in response to the trigger operation of the second user, the interface is jumped from the interface of the target object to the task center, to display the task details page of the first task corresponding to the task identifier in the task center.

In one implementation, a task card corresponding to the task identifier is displayed in response to the trigger operation on the task identifier by the second user, where the task card includes summary information of the first task and a second control; and the task details page is displayed in response to a trigger operation on the second control by the second user. That is, to enable the second user to understand basic information of the first task, when the second user triggers the task identifier, the summary information of the first task may be first displayed through the task card, for example, a task title, an executor, a collaborator, and a date. When the second user continues to trigger the second control in the task card, the task details page is displayed. The task details page may be displayed in the interface of the target object or may be displayed by jumping to the task center, which is not limited in this embodiment.

For example, FIG. 3b is a schematic diagram of a task card display. The target object is a first chat. In response to a click operation on a task identifier “t12347785”, a task card 300 is displayed in the interface of the first chat. The task card 300 includes a second control 301, and the second control 301 is used to call the task details page.

It should be noted that the foregoing implementations may be combined in any manner, which is not limited in this embodiment.

As shown, when the first user triggers the first preset operation about the first task, the task identifier corresponding to the first task is obtained based on the first preset operation. After the task identifier corresponding to the first task is obtained, when the first user triggers the second preset operation, the task identifier is displayed in the interface of the target object based on the second preset operation, so that the second user having an access permission to the target object views information corresponding to the first task through the task identifier. That is, the information corresponding to the first task is displayed by triggering the task identifier, which is convenient for the user to view the information, to improve user usage experience.

To avoid a user data leakage, an access permission of the task may be preset, and only a user having the access permission can view information of the task through the task identifier. In this embodiment, in response to displaying the task identifier in the interface of the target object, the access permission for the first task is granted to a user corresponding to the target object. That is, when the task identifier is added to the target object, it means that the access permission for the first task corresponding to the task identifier is granted to the user corresponding to the target object. For example, when the target object is a group chat, all group members in the group chat have the access permission; or when the target object is a cloud document, all collaborators of the cloud document have the access permission.

In some implementations, to enable the second user to intuitively understand whether the second user has the permission to access the first task, the second user may be prompted through different display effects. Specifically, if the second user has the access permission for the first task, the task identifier is displayed in the interface of the target object belonging to the second user in a first display manner; or if the second user does not have the access permission for the first task, the task identifier is displayed in the interface of the target object belonging to the second user in a second display manner. For example, the first display manner is “blue font+dashed underline”, and the second display manner is “gray font+dashed underline”. Further, to more intuitively prompt the second user that the second user has no permission to access the details page of the first task, when the second user hovers a mouse over the task identifier, a prompt “No access permission” is displayed around the task identifier.

In some implementations, if the second user has the access permission for the first task, the task details page is controlled to display detailed information of the first task. Further, the task details page may further include an edit control. The edit control is used to edit the first task, for example, to modify a due date, add or delete a collaborator, add a comment, or the like.

If the second user does not have the access permission for the first task, the task details page is controlled to display no-access permission prompt information. Further, to facilitate the second user to access detailed information of the first task, the task details page may include a first control, and the first control is used to apply for the access permission. In response to a trigger operation on the first control by the second user, a request for applying access permission is sent to a client of a creator of the first task.

In addition, the task can also be shared in an external client independent of the collaboration software. When the task is shared in the external client, an AppLink corresponding to the task is shared. When the user clicks the AppLink, if the electronic device on which the external client is located has the collaboration software installed, the user can be guided to open the collaboration software to display the task details page. If the electronic device on which the external client is located does not have the collaboration software installed, the task details page can be opened through a web page of the collaboration software.

Based on the foregoing method embodiments, an embodiment of the present application further provides a method of task processing. The method is described below.

The collaboration software is a suite software that integrates any of a plurality of functions such as an address book, an instant messaging tool, a meeting, a cloud document, a workbench, a task center, a calendar, an email box. The task center in the collaboration software is a lightweight task management tool with powerful collaboration capability, and a user can view all tasks related to the user in the task center. The user can easily and quickly create a task in a scenario such as a chat, or share an interested task with another user, or follow some interested tasks. In addition, the user can discuss the task or the like. When creating a task, the user can add a follower and a collaborator to the task. How to quickly share a task with another user, the present application provides a task transfer manner by using a task identifier, and the task identifier can be used for distinction and identification within a same tenant, that is, the task identifier is in a one-to-one correspondence with a task within one tenant.

The technical solution of the present application is applied to scenarios such as an instant messaging chat, an online document, and a task center. In these scenarios, it may be necessary to mention a specific task, and the task may be represented by using a task identifier of the task, but the identifier of the task needs to be in an analyzable state, so that the user or another user can learn content of the task by triggering the task identifier of the task.

Task identifiers of different tenants are independent to each other. That is, within one tenant, one task identifier corresponds to one unique task. In a cross-tenant scenario, one task identifier may correspond to two or more tasks.

For example, user 1 belongs to tenant A, and can access some tasks that can be accessed by the user 1 and that are created under tenant A. The tasks that can be accessed by user 1 and that are created under tenant A may be, for example, some tasks for which user 1 is a creator, an executor, a follower, a person responsible, or the like. For example, a task x1 corresponding to task identifier 11 and a task x2 corresponding to task identifier 12 are created under tenant A. Meanwhile, in a cross-tenant collaboration scenario, the person related to some tasks that are created by users under tenant B involves user 1, for example, user 1 is a follower or an executor of these tasks, and these tasks that are created by users under tenant B can be accessed by user 1. These tasks created under tenant B and that can be accessed by user 1 may be, for example, a task y1 corresponding to task identifier 21 and a task y2 corresponding to task identifier 22. Because task identifiers of tenant A and tenant B are independently generated, task identifier 11 and task identifier 21 may be the same, for example, both are t12345678.

Therefore, for some tasks, when a user needs to mention a specific task, after the user inputs a task identifier of the task, there may be a case that the task identifier of one task corresponds to two or more tasks. In the present application, related information of the two or more tasks is displayed, so that the user can select one of the tasks as a target task. After the user selects the target task, the task identifier is displayed in a first preset style. The task identifier displayed in the first preset style can be triggered to display content of the target task. Therefore, the user or another user can learn the content of the task by triggering the task identifier of the task.

The following describes the technical solution of the present application by using several specific embodiments. Names of buttons involved in the interfaces in the following embodiments are examples. Provided that the same function can be implemented, a specific name of the button is not limited.

FIG. 4 is a schematic flowchart of a method of task processing according to an embodiment of the present application. As shown in FIG. 4, the method in this embodiment is as follows:

Step S100: Receive a task analysis request triggered by a user, where the task analysis request indicates a first task identifier.

When the user needs to mention a specific task, the task that needs to be mentioned is described as a first task below, and the user can input the first task identifier at a specified input position. An identifier of the task may be a character or a character string that meets a preset rule requirement. For example, the rule may be that N Arabic numerals follow “t”, where N is a positive integer greater than or equal to 1, for example, 8. If such a character string is identified, it can be considered as the task identifier. For example, the first task identifier is “t62401256”.

Some scenarios are listed as examples: As shown in FIG. 5, the user can input the first task identifier in an instant messaging chat input box. Optionally, the user can also input the first task identifier in an online document editing interface. The user can also input the first task identifier in a task title input box of a task center, and the user can also input the first task identifier in a task comment area of the task center. In the description of each of the following embodiments, an instant messaging chat scenario is used as an example for illustration. Scenarios of other applications are similar and are not described one by one in the present application.

Optionally, an input manner in which the user inputs the first task identifier in the foregoing scenarios includes but is not limited to a text input manner and a voice input manner.

Three lists for storing task information are described below, which are respectively a first list, a second list, and a third list. The three lists involve information such as a global identifier, a user identifier, a task identifier.

The global identifier corresponds to a unique task in an entire task system. The entire task system includes task systems of all tenants. That is, in the entire task system, one global identifier corresponds to one unique task.

The user identifier corresponds to a unique user in the entire task system. The entire task system includes task systems of all tenants. That is, in the entire task system, one user identifier corresponds to one unique user.

The task identifier corresponds to a unique task in a task system of one tenant. That is, in a task system of one tenant, one task identifier corresponds to one unique task. In task systems of different tenants, there may be the same task identifier.

The first list uses a user identifier as an index, and correspondingly stores the user identifier, a task identifier, and a global identifier.

The second list uses the global identifier as an index, and correspondingly stores the global identifier, task description information, and tenant information of a task. The task description information includes one or more of the following: a task title, task body content, a task identifier, and the like.

The third list uses the global identifier as an index, and correspondingly stores the global identifier and member information related to the task. The member information related to the task includes persons having an access permission to the task, such as a task creator, a task follower, a task executor, and a person responsible for the task.

The following uses an example to describe a process of storing information in the foregoing three lists:
1) User 1 of tenant A creates task 1, where task description information 1 and member information related to the task of task 1 are as follows:

The task description information 1 is, for example: task title: project follow-up; task body content: completion of project A and project B; and the member information related to the task: task executor: user 2, task follower: user 3.

During creation of task 1, the system automatically generates a global identifier and a task identifier corresponding to task 1, for example, global identifier 1 and task identifier 1.

Correspondingly, in the first list, the following is stored: user 1, task identifier 1, and global identifier 1;
user 2, task identifier 1, and global identifier 1; and
user 3, task identifier 1, and global identifier 1.

In the second list, the following is stored: global identifier 1, task description information 1, and tenant A.

In the third list, the following is stored: global identifier 1, user 1, user 2, and user 3.
2) User 5 of tenant B creates task 2, where task description information 2 and member information related to the task of task 2 are as follows:

The task description information 2 is, for example: task title: product development; task body content: discussion on development of product A; and the member information related to the task: task executor: user 1, task follower: user 6;

During creation of task 2, the system automatically generates global identifier 2 and task identifier 1 corresponding to task 2, for example, global identifier 2 and task identifier 1.

Correspondingly, the following is added to the first list for storage: user 5, task identifier 1, and global identifier 2;
user 1, task identifier 1, and global identifier 2; and
user 6, task identifier 1, and global identifier 2.

In the second list, the following is added for storage: global identifier 2, task description information 2, and tenant B.

In the third list, the following is added for storage: global identifier 2, user 5, user 1, and user 6.

In a form of a table, the first list is shown in Table 1, the second list is shown in Table 2, and the third list is shown in Table 3.

TABLE 1

| User identifier | Task identifier | Global identifier |
|---|---|---|
| User 1 | Task identifier 1 | Global identifier 1 |
| User 2 | Task identifier 1 | Global identifier 1 |
| User 3 | Task identifier 1 | Global identifier 1 |
| User 5 | Task identifier 1 | Global identifier 2 |
| User 1 | Task identifier 1 | Global identifier 2 |
| User 6 | Task identifier 1 | Global identifier 2 |

TABLE 2

| | | Tenant |
|---|---|---|
| Global identifier | Task description information | information |
| Global identifier 1 | Task description information 1 | Tenant A |
| Global identifier 2 | Task description information 2 | Tenant B |

TABLE 3

| Global identifier | User identifier |
|---|---|
| Global identifier 1 | User 1, User 2, and User 3 |
| Global identifier 2 | User 5, User 1, and User 6 |

After receiving the first task identifier input by the user, at least two candidate tasks which the user has an access permission to and which task identifiers match the first task identifier, and tenant information of the at least two candidate tasks are obtained based on an identifier of the user and the first task identifier.

Specifically, the following possible implementation manners are included but not limited to:

Query the first list based on the identifier of the user and the first task identifier, to obtain global identifiers respectively corresponding to the at least two candidate tasks which the user has an access permission to and which task identifiers match the first task identifier. The first list uses a user identifier as an index, and correspondingly stores the user identifier, a task identifier, and a global identifier.

It is assumed that the first task identifier input by user 1 of tenant A is task identifier 1. The first list (shown in Table 1) is queried based on user 1 and task identifier 1, and it can be acquired that the global identifiers respectively corresponding to two candidate tasks which user 1 has an access permission to and which task identifiers match task identifier 1 are global identifier 1 and global identifier 2.

Query the second list based on the global identifiers respectively corresponding to the at least two candidate tasks, to acquire tenant information respectively corresponding to the at least two candidate tasks. The second list uses a global identifier as an index, and correspondingly stores the global identifier, task description information, and tenant information of a task.

The second list (shown in Table 2) is queried based on global identifier 1 and global identifier 2 corresponding to the two candidate tasks, and it can be acquired that tenant information respectively corresponding to the at least two candidate tasks is that tenant information corresponding to global identifier 1 is tenant A, and tenant information corresponding to global identifier 2 is tenant B.

Optionally, on the basis of the foregoing, the method further includes:
maintaining a third list, where the third list uses a global identifier as an index, to correspondingly store the global identifier and member information related to a task.

To further verify accuracy of the obtained at least two candidate tasks corresponding to the task identifier and tenant information respectively corresponding to the candidate tasks.

After the tenant information corresponding to the candidate tasks is obtained, the third list is further queried based on the global identifiers respectively corresponding to the at least two candidate tasks, to determine whether the identifier of the user exists in task member related information corresponding to the at least two candidate tasks. If the identifier of the user does not exist in the task member related information corresponding to one candidate task, the task is deleted from the candidate tasks.

For example, user identifiers corresponding to global identifier 2 in Table 3 are: user 5, user 7, and user 6. In other words, at present, user 1 has no access permission to the candidate task corresponding to the global identifier 2 in the third list. Therefore, the task corresponding to global identifier 2 is deleted from the candidate tasks. Therefore, the accuracy of the obtained candidate tasks is further ensured.

When the third list changes, the first list is updated according to the change. After a task is created, member information related to the task may be adjusted due to factors such as a change in persons. After the member information related to the task changes, the third list needs to be changed accordingly. For example, the member information of the task corresponding to global identifier 2 changes from user 5, user 1, and user 6 to user 5, user 7, and user 6. That is, a task accessible to user 1 in the first list needs to be updated, that is, a record of the task corresponding to global identifier 2 accessible to user 1 is deleted. When the update is not timely, a situation in the foregoing example occurs, that is, user 1 has no access permission to the task corresponding to global identifier 2 (user 1 originally has access permission to the task corresponding to global identifier 2, but the task corresponding to global identifier is modified later, and user 1 is removed from persons related to the task). Therefore, it is necessary to further verify, according to the third list, an access permission of the user to the task.

Step S200: When an analysis result corresponding to the first task identifier includes at least two candidate tasks, display related information of the at least two candidate tasks.

The related information includes: tenant information corresponding to each candidate task.

In one tenant, one task identifier corresponds to a unique task in the tenant, that is, a task identifier corresponds to a unique task in a task system of one tenant. Therefore, tenant information of the at least two candidate tasks included in an analysis result of the first task identifier is different.

In one implementation: when the analysis result corresponding to the first task identifier includes the at least two candidate tasks, display a floating window, where the related information of the at least two candidate tasks is displayed in the floating window.

Optionally, the related information of the task may further include: task description information, where the task description information includes but is not limited to one or more of the following: title information of the task, body content of the task, a task identifier, an executor of the task, a follower, a person responsible for the task, a due time of the task, and the like.

An example in which the analysis result corresponding to the first task identifier includes two candidate tasks is illustrated for description. Tenant information corresponding to a first candidate task is tenant A, and tenant information corresponding to a second candidate task is tenant B.

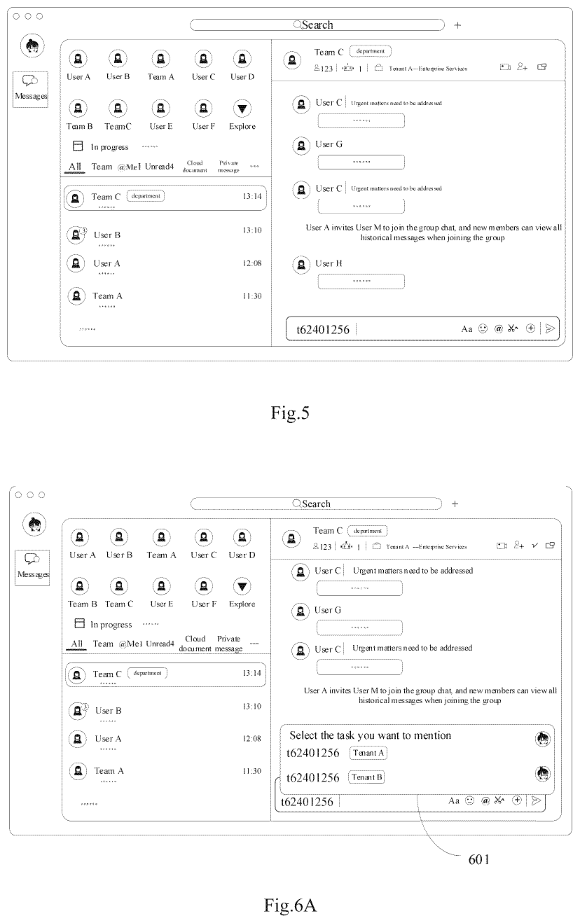

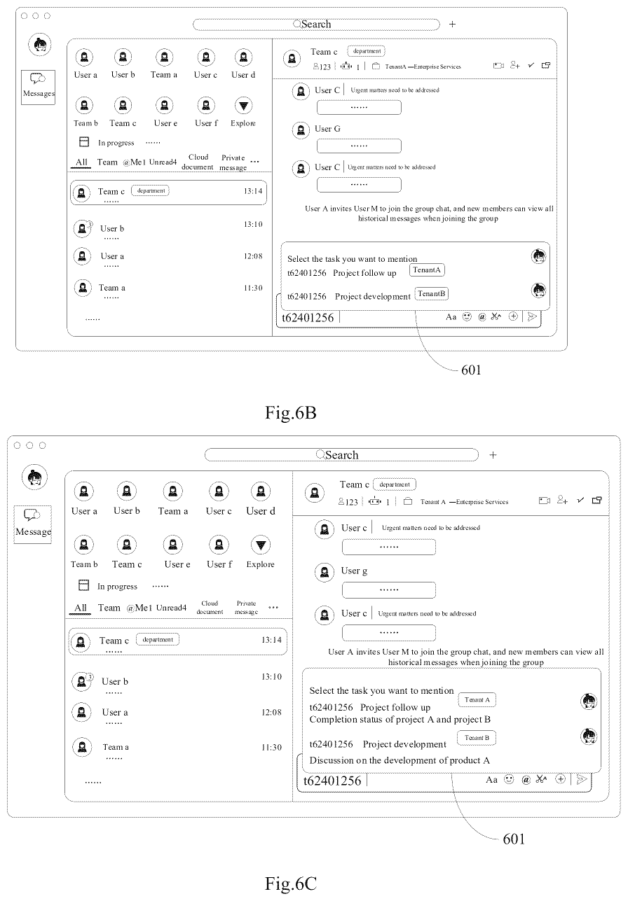

As shown in FIG. 6A, a floating window 601 is displayed, and an analysis result is displayed in the floating window 601. Only tenant A and tenant B may be displayed. The user can select an option of tenant A or an option of tenant B as required, to determine the candidate task corresponding to the selected tenant as a target task.

Title information of the task may also be displayed at the same time. As shown in FIG. 6B, the tenant information is displayed after the corresponding title information, so that the user can select the target task based on the title information and the tenant information.

Optionally, specific content of the task may also be displayed at the same time. As shown in FIG. 6C, the specific content of the task is displayed below the title information of the task, so that the user can select the target task based on richer information, that is, select the target task according to the tenant information, the title information of the task, and the specific content of the task.

Step S300: Display the first task identifier in a first preset style in response to an operation of the user selecting one of the candidate tasks as a target task, where the first task identifier displayed in the first preset style is capable of being triggered to display content of the target task.

The first preset style is used to indicate identifier information of the target task being in an analyzable state. In other words, the first task identifier displayed in the first preset style can be understood as being in an analyzable state and can be triggered by a preset operation to display the content of the target task.

The user can select one of the candidate tasks as the target task in a manner such as clicking. For example, task 1 is selected as the target task. After the target task is determined, the first task identifier is displayed in the first preset style, that is, the first task identifier is in an analyzable state. When the first task identifier in the analyzable state is triggered by the preset operation, the content of the target task is displayed. The preset operation includes but is not limited to clicking the first task identifier.

Displaying in the first preset style includes but is not limited to the following possible implementations:

Displaying in a preset color. For example, in a non-analyzable state, the first task identifier is displayed in black. In an analyzable state, the first task identifier is displayed in blue.

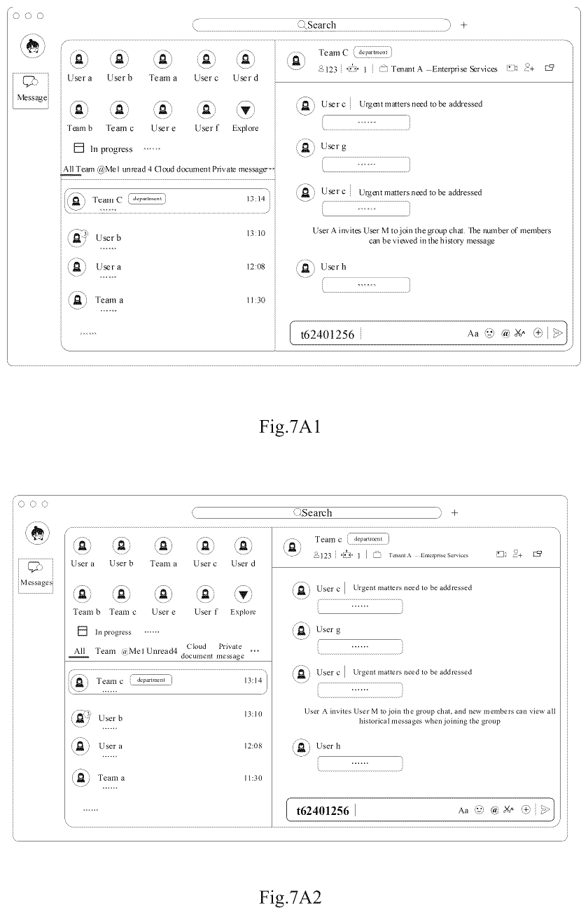

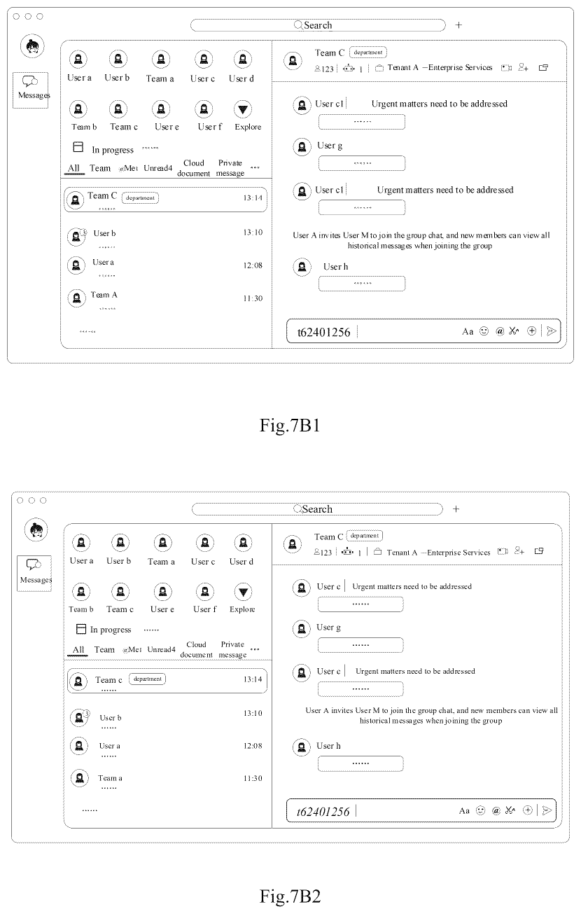

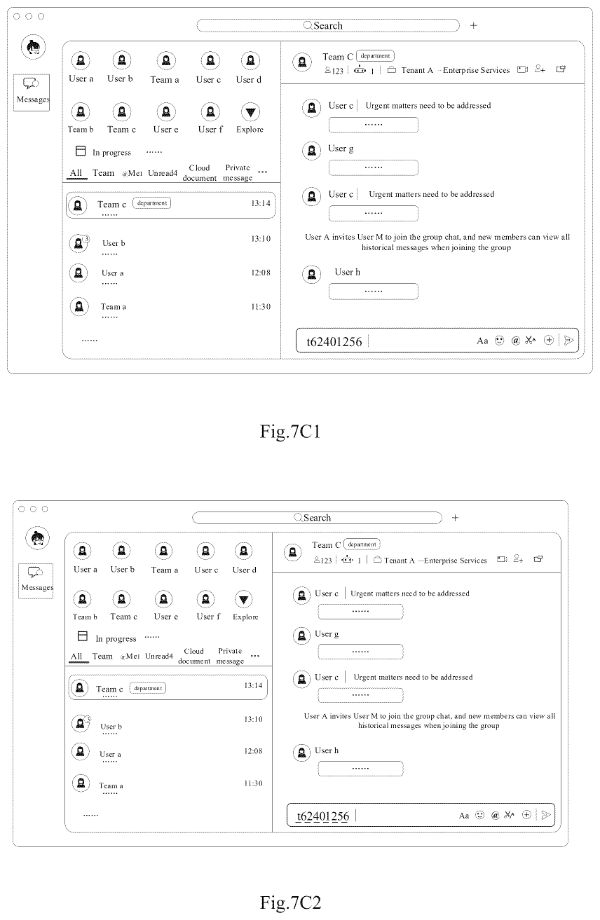

Displaying in a preset thickness. For example, in a non-analyzable state, the first task identifier is displayed with a thickness the same as that of another character, as shown in FIG. 7A1. In an analyzable state, the first task identifier is displayed in a bold state, as shown in FIG. 7A2.

Displaying in a preset inclination. For example, in a non-analyzable state, the first task identifier is displayed in a non-inclined manner, as shown in FIG. 7B1. In an analyzable state, the first task identifier is displayed in an inclined state, as shown in FIG. 7B2.

Displaying with an underline at the bottom. For example, in a non-analyzable state, there is no underline at the bottom of the first task identifier, as shown in FIG. 7C1. In an analyzable state, there is an underline at the bottom of the first task identifier, as shown in FIG. 7C2. The underline may be a solid line or a dashed line and the dashed line is illustrated as an example in the drawings.

In this embodiment, the task analysis request triggered by the user is received. When the analysis result corresponding to the first task identifier includes at least two candidate tasks, the related information of the at least two candidate tasks is displayed. The related information includes: tenant information corresponding to each candidate task. Therefore, the user can determine one of the candidate tasks as a target task based on the related information of the candidate tasks. The first task identifier is displayed in a first preset style in response to an operation of the user selecting one of the candidate tasks as the target task. The first task identifier displayed in the first preset style is capable of being triggered to display content of the target task. Therefore, a task identifier of a cross-tenant user can be analyzed.

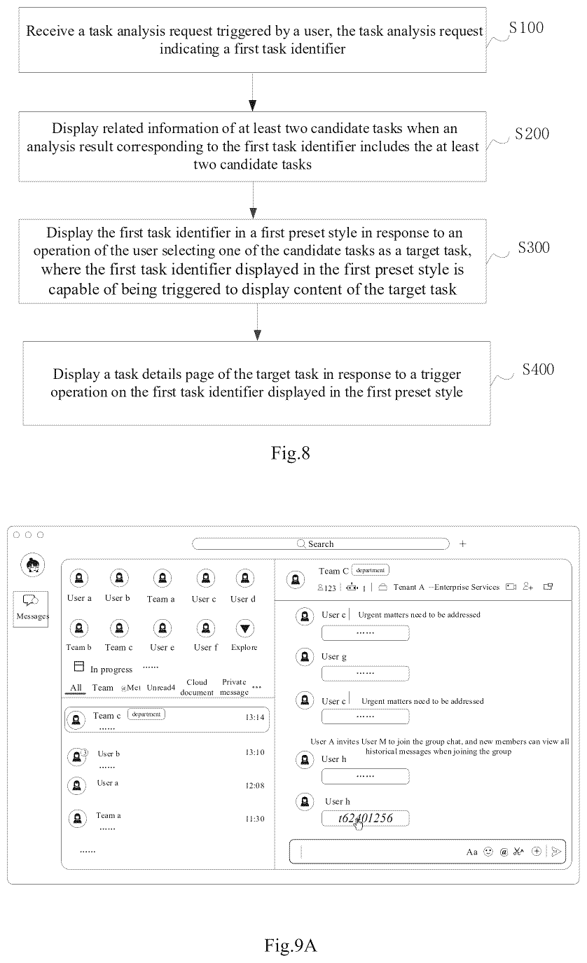

Optionally, on the basis of the foregoing embodiment, after the user sends a message including the first task identifier displayed in the first preset style, the method further includes S400, as shown in FIG. 8:

Step S400: Display a task details page of a target task in response to a trigger operation on the first task identifier displayed in the first preset style.

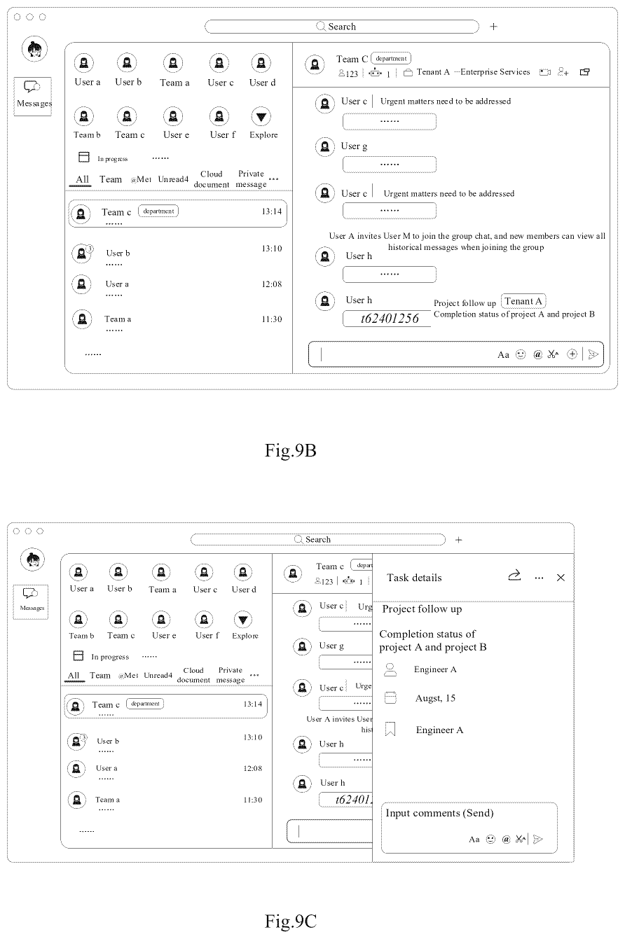

Any user in a chat triggers the first task identifier displayed in the first preset style by using a preset operation, for example, clicking, as shown in FIG. 9A. Then a task details page of the target task is displayed, as shown in FIG. 9B. In another embodiment of the present application, in response to triggering the first task identifier displayed in the first preset style, the task details page is displayed on an interface of the chat in a sidebar manner (as shown in FIG. 9C), or it is jumped to a task details page interface about the first task in a task center.

Therefore, the first task identifier of the cross-tenant user can be analyzed, so that the user and another user can learn content of the analyzed task.

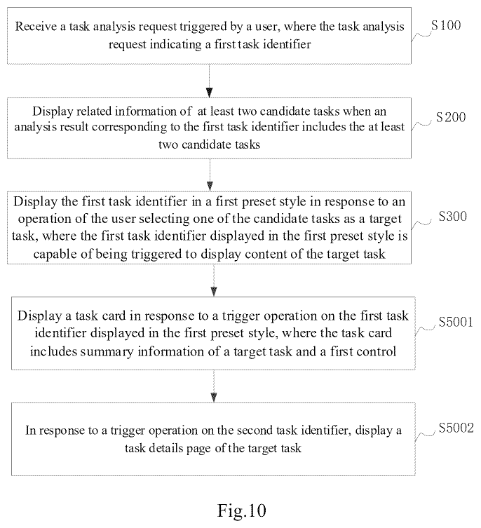

Optionally, FIG. 10 is another alternative implementation of FIG. 8. On the basis of the foregoing embodiment, after the user sends a message including the first task identifier displayed in the first preset style, the method further includes S5001 and S5002, as shown in FIG. 10:

Step S5001: Display a task card in response to a trigger operation on the first task identifier displayed in the first preset style, where the task card includes summary information of a target task and a first control.

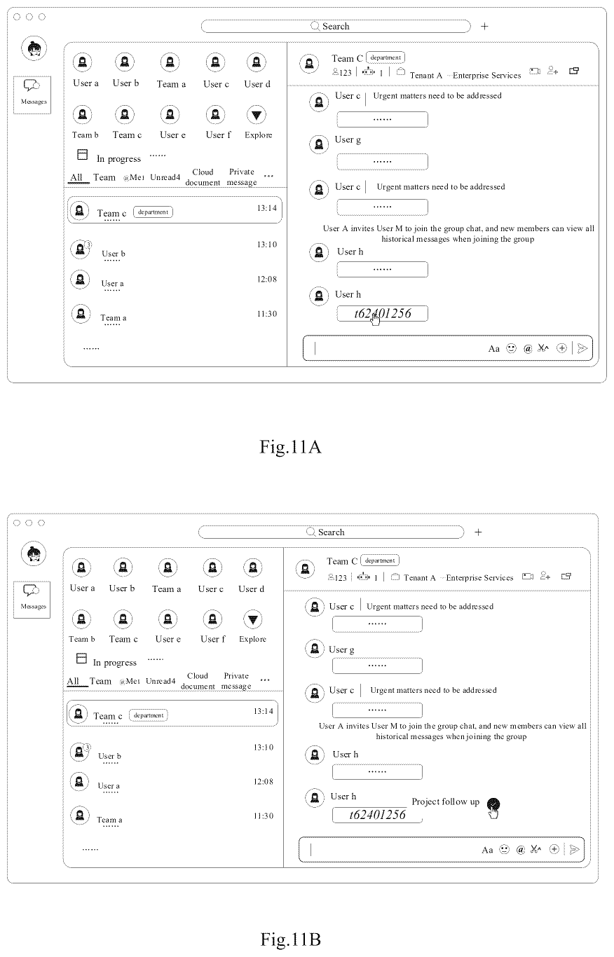

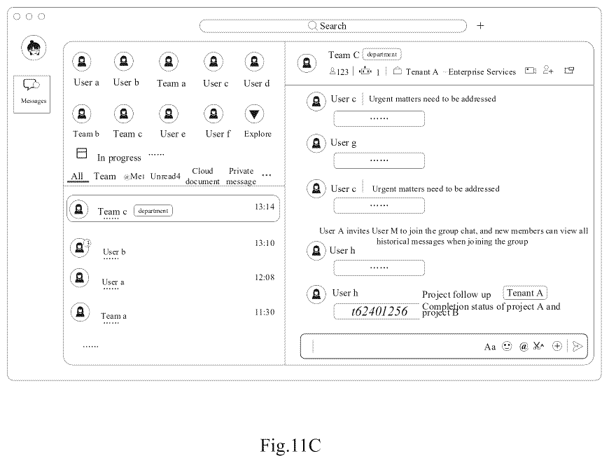

The trigger operation on the first task identifier displayed in the first preset style is as shown in FIG. 11A. In response to the trigger operation on the first task identifier displayed in the first preset style, for example, a click operation, the task card is displayed. The task card includes the summary information of the target task and the first control, as shown in FIG. 11B. The summary information of the target task may be title information of the target task.

Step S5002: Display a task details page of the target task in response to a trigger operation on the first control.

If the user wants to further learn the task details page of the target task, the user can trigger the first control. For example, the user clicks the first control, and the task details page of the target task is displayed, as shown in FIG. 11C.

Therefore, the first task identifier of the cross-tenant user can be analyzed, so that the user and another user can learn content of the analyzed task.

In the foregoing embodiment, optionally, if the user does not select any candidate task, the first task identifier is displayed in a style of a normal text. Displaying the first task identifier in the style of the normal text means that the task identifier is in an unanalyzable state, and is merely a string of characters.

Based on the foregoing method embodiments, an embodiment of the present application provides an apparatus of information processing. The following describes the apparatus with reference to the accompanying drawings.

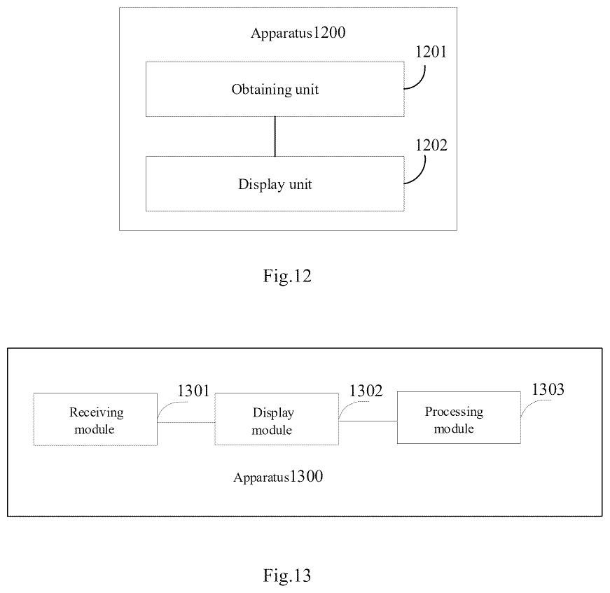

Referring to FIG. 12, FIG. 12 is a block diagram of an apparatus of information processing according to an embodiment of the present application. As shown in FIG. 12, the apparatus may include: an obtaining unit 1201 and a display unit 1202.

The obtaining unit 1201 is configured to obtain a task identifier corresponding to a first task in response to a first preset operation about the first task triggered by a first user.

The display unit 1202 is configured to display the task identifier in an interface of a target object in response to a second preset operation triggered by the first user, so that a second user having an access permission to the target object views information corresponding to the first task through the task identifier.

In an embodiment of the present application, the display unit 1202 is further configured to display a task details page corresponding to the task identifier in response to a trigger operation on the task identifier by the second user, where the task details page is used to display detailed information of the first task.

In an embodiment of the present application, the display unit 1202 is specifically configured to display the task details page on a page including the task identifier in response to the trigger operation on the task identifier by the second user; and/or jump to a task center and display the task details page in the task center in response to the trigger operation on the task identifier by the second user.

In an embodiment of the present application, the apparatus further includes: a control unit;

The control unit is configured to control the task details page to display detailed information of the first task if the second user has an access permission to the first task; or control the task details page to display no-access permission prompt information if the second user does not have the access permission to the first task.

In an embodiment of the present application, if the second user has an access permission to the first task, the task details page further includes an edit control, and the edit control is used to edit the first task.

In an embodiment of the present application, if the second user does not have the access permission to the first task, the task details page further includes a first control, and the first control is used to apply for the access permission.

In an embodiment of the present application, the display unit 1202 is specifically configured to display a task card corresponding to the task identifier in response to a trigger operation on the task identifier by the second user, where the task card includes summary information of the first task and a second control; and display the task details page in response to a trigger operation on the second control by the second user.

In an embodiment of the present application, the display unit 1202 is specifically configured to display the task identifier in a first display manner in an interface of the target object belonging to the second user if the second user has an access permission to the first task; or display the task identifier in a second display manner in an interface of the target object belonging to the second user if the second user does not have the access permission to the first task.

In an embodiment of the present application, the obtaining unit 1201 is specifically configured to obtain a preset symbol input by the first user in an input area in an interface of the target object in response to the preset symbol, and display a task identifier including the preset symbol; obtain a selected task identifier in response to a selection operation of the displayed task identifier by the first user; or obtain a task identifier corresponding to the first task in response to a copy or share operation on the first task triggered by the first user.

In an embodiment of the present application, the apparatus further includes: a configuration unit;

The configuration unit is configured to grant an access permission for the first task to a user corresponding to the target object in response to displaying the task identifier in an interface of the target object.

In an embodiment of the present application, the target object includes one or more of an instant messaging IM chat, a cloud document, and a task comment area.

Based on the foregoing method embodiments, an embodiment of the present application further provides an apparatus of task processing. As shown in FIG. 13, FIG. 13 is a schematic diagram of a structure of an apparatus of task processing according to the present application.

The apparatus 1300 in this embodiment includes: a receiving module 1301, a display module 1302, and a processing module 1303, where

The receiving module 1301 is configured to receive a task analysis request triggered by a user, where the task analysis request indicates a first task identifier;

The display module 1302 is configured to display related information of at least two candidate tasks when an analysis result corresponding to the first task identifier includes the at least two candidate tasks, where the related information includes: tenant information corresponding to each candidate task; and

The processing module 1303 is configured to display the first task identifier in a first preset style in response to an operation of the user selecting one of the candidate tasks as a target task, where the first task identifier displayed in the first preset style is capable of being triggered to display content of the target task.

Optionally, the tenant information of the at least two candidate tasks is different;

In one tenant, one task identifier corresponds to a unique task in the tenant.

Optionally, the processing module 1303 is further configured to display a task details page of the target task in response to a trigger operation on the first task identifier displayed in the first preset style;
or
display a task card in response to a trigger operation on the first task identifier displayed in the first preset style, where the task card includes summary information of a target task and a first control; and display a task details page of the target task in response to a trigger operation on the first control.

Optionally, the displaying in the first preset style includes at least one of the following:
displaying in a preset color;
displaying in a preset thickness;
displaying in a preset inclination; and
displaying with an underline at the bottom.

Optionally, the display module 1302 is specifically configured to display a floating window when the analysis result corresponding to the first task identifier includes the at least two candidate tasks, where the related information of the at least two candidate tasks is displayed in the floating window.

Optionally, the receiving module 1301 is specifically configured to receive an operation of the user inputting the first task identifier at a specified input position.

Optionally, the inputting the first task identifier includes: inputting text or inputting voice; and/or the specified input position includes one or more of the following: an instant messaging chat input box, an online document editing interface, a task title input box, and a task comment.

Optionally, if the user does not select any candidate task, the first task identifier is displayed in a style of a normal text.

Optionally, the related information further includes: task description information.

Optionally, the processing module 1303 is further configured to obtain, based on an identifier of the user and the first task identifier, at least two candidate tasks which the user has an access permission to and which task identifiers match the first task identifier, and tenant information of the at least two candidate tasks.

Optionally, the processing module 1303 is specifically configured to query a first list based on the identifier of the user and the first task identifier, to acquire global identifiers respectively corresponding to the at least two candidate tasks which the user has an access permission to and which task identifiers match the first task identifier; where the first list uses a user identifier as an index, and correspondingly stores the user identifier, a task identifier, and a global identifier; and query a second list based on the global identifiers respectively corresponding to the at least two candidate tasks, to acquire tenant information respectively corresponding to the at least two candidate tasks; where the second list uses a global identifier as an index, and correspondingly stores the global identifier, task description information, and tenant information of a task.

Optionally, the processing module 1303 is further configured to maintain a third list, where the third list uses a global identifier as an index, and correspondingly stores the global identifier and member information related to a task;
query the third list based on the global identifiers respectively corresponding to the at least two candidate tasks, to determine whether the identifier of the user exists in task member related information corresponding to the at least two candidate tasks. If the identifier of the user does not exist in the task member related information corresponding to one candidate task, the task is deleted from the candidate tasks.

Optionally, the processing module 1303 is further configured to update the first list according to a change when the third list changes.

It should be noted that, for a specific implementation of each unit in this embodiment, reference may be made to related descriptions in the foregoing method embodiments.

The division of the units in this embodiment of the present application is schematic and is merely a logical function division. In actual implementation, there may be another division manner. Each functional unit in this embodiment of the present application may be integrated into one processing unit, each unit may exist alone physically, or two or more units may be integrated into one unit. For example, in the foregoing embodiment, the processing unit and the sending unit may be the same unit, or may be different units. The foregoing integrated unit may be implemented in a form of hardware or may be implemented in a form of a software functional unit.

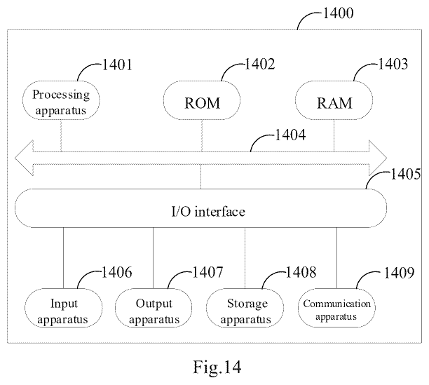

Referring to FIG. 14, FIG. 14 is a schematic diagram of a structure of an electronic device 1400 suitable for implementing an embodiment of the present disclosure. A terminal device in this embodiment of the present disclosure may include, but is not limited to, a mobile terminal such as a mobile phone, a notebook computer, a digital broadcast receiver, a personal digital assistant (PDA), a tablet computer (PAD), a portable multimedia player (PMP), and a vehicle-mounted terminal (for example, a vehicle navigation terminal), and a fixed terminal such as a digital TV and a desktop computer. The electronic device shown in FIG. 14 is merely an example, and shall not impose any limitation on the function and scope of use of the embodiments of the present disclosure.

As shown in FIG. 14, the electronic device 1400 may include a processing apparatus (for example, a central processing unit, a graphics processing unit, or the like) 1401 that may perform a variety of appropriate actions and processing in accordance with a program stored in a read-only memory (ROM) 1402 or a program loaded from a storage apparatus 1408 into a random access memory (RAM) 1403. The RAM 1403 further stores various programs and data required for the operation of the electronic device 1400. The processing apparatus 1401, the ROM 1402, and the RAM 1403 are connected to each other through a bus 1404. An input/output (I/O) interface 1405 is also connected to the bus 1404.

Generally, the following apparatuses may be connected to the I/O interface 1405: an input apparatus 1406 including, for example, a touchscreen, a touchpad, a keyboard, a mouse, a camera, a microphone, an accelerometer, and a gyroscope; an output apparatus 1407 including, for example, a liquid crystal display (LCD), a speaker, and a vibrator; the storage apparatus 1408 including, for example, a tape and a hard disk; and a communication apparatus 1409. The communication apparatus 1409 may allow the electronic device 1400 to perform wireless or wired communication with other devices to exchange data. Although FIG. 14 shows the electronic device 1400 having various apparatuses, it should be understood that it is not required to implement or have all the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 1409 and installed, installed from the storage apparatus 1408, or installed from the ROM 1402. When the computer program is executed by the processing apparatus 1401, the above-mentioned functions defined in the method of the embodiment of the present disclosure are performed.

The electronic device provided in the embodiment of the present disclosure and the method provided in the above embodiment belong to the same inventive concept. Technical details not described in detail in this embodiment may be found in the above embodiment, and this embodiment and the above embodiment have the same beneficial effects.

An embodiment of the present disclosure provides a computer storage medium having a computer program stored thereon, where when the program is executed by a processor, the method provided in the above embodiment is implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, where the data signal carries computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained on the computer-readable medium may be transmitted by any suitable medium, including but not limited to: electric wires, optical cables, radio frequency (RF), and the like, or any suitable combination thereof.

In some implementations, the client and the server may communicate using any currently known or future-developed network protocol such as Hyper Text Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device; or may exist independently without being assembled into the electronic device.

The above computer-readable medium carries one or more programs, and when the one or more programs are executed by the electronic device, the electronic device can execute the above method.

The computer program code for performing the operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet using an Internet service provider).

The flowcharts and block diagrams in the accompanying drawings illustrate the possibly implemented system architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by means of software, or may be implemented by means of hardware. The name of a unit/a module does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include but is not limited to electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that in this specification, the embodiments are described in a progressive manner, and each embodiment focuses on differences from other embodiments. For the same or similar parts between the embodiments, refer to each other. For a system or apparatus disclosed in the embodiments, since it corresponds to a method disclosed in the embodiments, the description is relatively simple, and for related parts, refer to the description of the method section.

It should be understood that in this application, “at least one (item)” means one or more, and “a plurality of” means two or more. “And/or” is used to describe an association relationship between associated objects and indicates that there may be three relationships. For example, “A and/or B” may indicate: only A exists, only B exists, and both A and B exist. Among them, A and B may be singular or plural. The character “/” generally indicates that the associated objects before and after are in an “or” relationship. “At least one of the following items (pieces)” or a similar expression thereof means any combination of these items, including a single item (piece) or any combination of a plurality of items (pieces). For example, at least one of a, b, or c may indicate: a, b, c, “a and b”, “a and c”, “b and c”, or “a and b and c”, where a, b, and c may be single or multiple.

It should also be noted that in this article, relational terms such as first and second are only used to distinguish one entity or operation from another entity or operation, and do not necessarily require or imply that there is any such actual relationship or order between these entities or operations. Moreover, the terms “include”, “include” or any other variant thereof are intended to cover non-exclusive inclusion, so that a process, method, article or device that includes a series of elements not only includes those elements, but also includes other elements not explicitly listed, or it also includes elements inherent to such a process, method, article, or device. Without more restrictions, an element defined by the sentence “including a . . . ” does not exclude the existence of other identical elements in the process, method, article, or device including the element.

The steps of the method or algorithm described in connection with the embodiments disclosed herein may be implemented directly in hardware, a software module executed by a processor, or a combination of the two. The software module can be placed in random access memory (RAM), memory, read-only memory (ROM), electrically programmable ROM, electrically erasable programmable ROM, registers, hard disks, removable disks, CD-ROMs, or any other form of storage medium known in the art.

The foregoing descriptions of the disclosed embodiments enable those skilled in the art to implement or use the present application. Various modifications to these embodiments will be apparent to those skilled in the art, and the general principles defined herein can be implemented in other embodiments without departing from the spirit or scope of the present application. Therefore, the present application will not be limited to the embodiments shown herein but is to be consistent with the widest scope consistent with the principles and novel features disclosed herein.

1. A method of information processing, comprising:
obtaining a task identifier corresponding to a first task in response to a first preset operation about the first task triggered by a first user; and
displaying the task identifier in an interface of a target object in response to a second preset operation triggered by the first user, so that a second user having an access permission to the target object views information corresponding to the first task through the task identifier.

2. The method according to claim 1, further comprising:
displaying a task details page corresponding to the task identifier in response to a trigger operation on the task identifier by the second user, wherein the task details page is used to display detailed information about the first task.

3. The method according to claim 2, wherein the displaying a task details page corresponding to the task identifier in response to a trigger operation on the task identifier by the second user comprises one or more of the following:
displaying the task details page on an interface of the target object displaying the task identifier in response to the trigger operation on the task identifier by the second user; and
jumping to a task center and displaying the task details page in the task center in response to the trigger operation on the task identifier by the second user.

4. The method according to claim 2, further comprising:
controlling the task details page to display detailed information about the first task if the second user has an access permission to the first task; or
controlling the task details page to display no-access permission prompt information if the second user does not have the access permission to the first task.

5. The method according to claim 4, wherein if the second user has an access permission to the first task, the task details page further comprises an edit control, and the edit control is used to edit the first task.

6. The method according to claim 4, wherein if the second user does not have the access permission to the first task, the task details page further comprises a first control, and the first control is used to apply for the access permission.

7. The method according to claim 2, wherein the displaying a task details page corresponding to the task identifier in response to a trigger operation on the task identifier by the second user comprises:
displaying a task card corresponding to the task identifier in response to a trigger operation on the task identifier by the second user, wherein the task card comprises summary information of the first task and a second control; and
displaying the task details page in response to a trigger operation on the second control by the second user.

8. The method according to claim 1, wherein the displaying the task identifier in an interface of a target object comprises:
displaying the task identifier in a first display manner in an interface of the target object belonging to the second user if the second user has an access permission to the first task; or
displaying the task identifier in a second display manner in an interface of the target object belonging to the second user if the second user does not have the access permission to the first task.

9. The method according to claim 1, wherein the obtaining a task identifier corresponding to a first task in response to a first preset operation about the first task triggered by a first user comprises:
obtaining a preset symbol input by the first user in an input area in an interface of the target object in response to the preset symbol, and displaying a task identifier including the preset symbol; obtaining a selected task identifier in response to a selection operation of the displayed task identifier by the first user; or
obtaining a task identifier corresponding to the first task in response to a copy or share operation about the first task triggered by the first user.

10. The method according to claim 1, further comprising:
granting an access permission for the first task to a user corresponding to the target object in response to displaying the task identifier in an interface of the target object.

11. The method according to claim 1, wherein the target object comprises one or more of an instant messaging IM chat, a cloud document, and a task comment area.

12. A method of task processing, comprising:
receiving a task analysis request triggered by a user, wherein the task analysis request indicates a first task identifier;
displaying related information of at least two candidate tasks when an analysis result corresponding to the first task identifier comprises the at least two candidate tasks, wherein the related information comprises: tenant information corresponding to each candidate task; and
displaying the first task identifier in a first preset style in response to an operation of the user selecting one of the candidate tasks as a target task, wherein the first task identifier displayed in the first preset style is capable of being triggered to display content of the target task.

13. The method according to claim 12, wherein
the tenant information of the at least two candidate tasks is different; and
in one tenant, one task identifier corresponds to a unique task in the tenant.

14. The method according to claim 12, further comprising:
displaying a task details page of the target task in response to a trigger operation on the first task identifier displayed in the first preset style; or
displaying a task card in response to a trigger operation on the first task identifier displayed in the first preset style, wherein the task card comprises summary information of a target task and a first control; and
displaying a task details page of the target task in response to a trigger operation on the first control.

15. The method according to claim 12, wherein the displaying in the first preset style comprises at least one of the following:
displaying in a preset color;
displaying in a preset thickness;
displaying in a preset inclination; and
displaying with an underline at the bottom.

16. The method according to claim 12, wherein the displaying related information of at least two candidate tasks when an analysis result corresponding to the first task identifier comprises the at least two candidate tasks comprises:
displaying a floating window when the analysis result corresponding to the first task identifier comprises the at least two candidate tasks, wherein the related information of the at least two candidate tasks is displayed in the floating window.

17. The method according to claim 12, wherein the receiving a task analysis request triggered by a user comprises:
receiving an operation of the user inputting the first task identifier at a specified input position.

18. The method according to claim 17, wherein the method comprises at least one of the following:
the inputting the first task identifier comprises: inputting text or inputting voice; and
the specified input position comprises one or more of the following: an instant messaging chat input box, an online document editing interface, a task title input box, and a task comment.

19. The method according to claim 12, further comprising:
if the user does not select any candidate task, displaying the first task identifier in a style of a normal text.

20. The method according to claim 12, wherein the related information further comprises: task description information.

21.-27. (canceled)
